(19) United States
(12) Patent Application Publication
(10) Pub. No.: US 2021/0241042 A1
(43) Pub. Date: Aug. 5, 2021

(54) CLASSIFIER EVALUATION DEVICE, CLASSIFIER EVALUATION METHOD, AND NON-TRANSITORY COMPUTER READABLE RECORDING MEDIUM

(71) Applicant: NIPPON TELEGRAPH AND TELEPHONE CORPORATION, Tokyo (JP)

(72) Inventors: Takaaki HASEGAWA, Tokyo (JP); Yoshiaki NODA, Tokyo (JP); Setsuo YAMADA, Tokyo (JP)

(73) Assignee: NIPPON TELEGRAPH AND TELEPHONE CORPORATION, Tokyo (JP)

(21) Appl. No.: 17/268,546

(22) PCT Filed: Aug. 14, 2019
(86) PCT No.: PCT/JP2019/031935

§ 371 Date: Feb. 15, 2021

(30) Foreign Application Priority Data
Aug. 15, 2018 (JP) 2018-152895

(51) Int. Cl. G06K 9/62; G06N 20/00

(52) U.S. Cl. CPC G06K 9/6262; G06N 20/00; G06K 9/6268

(57) ABSTRACT

The disclosure allows quick and accurate confirmation of the degree to which a presently used classifier (model) conforms to data for which no ground truth exists. The classifier evaluation device (1) comprises: a data count obtainment unit (18) for obtaining a data count of input data to be made a classification target; a correction frequency counter (17) for counting a correction frequency of the classifiers, from correction information of classification results for the classifiers; and a correction rate calculation unit (19) for calculating, based on, the correction frequency and the data count of input data a correction rate for each of the classifiers.

### TECHNICAL FIELD

The present invention relates to a classifier evaluation device, a classifier evaluation method, and a program.

### BACKGROUND

Machine learning techniques may be broadly classified as trained learning in which learning is performed whilst adding ground truth labels to learning data, untrained learning in which learning is performed without adding labels to learning data, and reinforcement learning in which a computer is induced to autonomously derive an optimal method by rewarding good results. For example, a support vector machine (SVM) that performs class classification is known as an example of trained learning (see, NPL 1).

### CITATION LIST

### Non-Patent Literature

NPL 1: Hiroya Takamura, “An Introduction to Machine Learning for Natural Language Processing”, CORONA PUBLISHING CO., LTD., 2010 Aug. 5, pp. 117-127.

### SUMMARY

### Technical Problem

Technologies for calculating accuracy (conformance rate and recall rate) of evaluation data have been proposed, but it is not possible to quickly and accurately confirm the degree to which a presently used classifier (model) conforms to data for which no ground truth exists. Thus, it is difficult to update the model at an appropriate timing.

An objective of the present invention, made in view of the abovementioned issues, is to provide a classifier evaluation device, a classifier evaluation method, and a program capable of quickly and accurately confirming how much a presently used classifier (model) conforms to data for which no ground truth exists.

### Solution to Problem

In order to resolve the abovementioned problem, the classifier evaluation device of the present invention is a classifier evaluation device for evaluating classifiers performing classification of input data, the classifier evaluation device comprising: a data count obtainment unit for obtaining a data count of input data to be made a classification target; a correction frequency counter for counting a correction frequency of the classifiers, from correction information on classification results for the classifiers; and a correction rate calculation unit for calculating, based on, the correction frequency and the data count of input data, a correction rate for each of the classifiers.

In order to resolve the abovementioned problem, the classifier evaluation method of the present invention is a classifier evaluation method for evaluating classifiers performing classification of input data, the method comprising: obtaining a data count of input data to be made a classification target; counting a correction frequency of the classifiers, from correction information on classification results for the classifiers; and calculating, based on the correction frequency and the data count of input data, a correction rate for each of the classifiers.

Further, to solve the abovementioned problems, a program pertaining to present invention causes a computer to function as the abovementioned classifier evaluation device.

### Advantageous Effect

According to the present invention, it is possible to quickly and accurately confirm how much a presently used classifier (model) conforms to data for which no ground truth exists.

### BRIEF DESCRIPTION OF THE DRAWINGS

In the accompanying drawings:

FIG. 1 is a block diagram of an example configuration of a classifier evaluation device according to an embodiment of the present invention;

FIG. 2 is a diagram showing an example of classification of input data groups using multi-class classifiers;

FIG. 3 is a diagram showing an example of a classification dependency relation table generated by the classifier evaluation device according to an embodiment of the present invention;

FIG. 4 is a diagram showing an example of a classification result table generated by the classifier evaluation device according to an embodiment of the present invention;

FIG. 5 is a diagram showing an example of a learning form generated by the classifier evaluation device according to an embodiment of the present invention;

FIG. 6 is a diagram showing a first correction example of a learning form generated by the classifier evaluation device according to an embodiment of the present invention;

FIG. 7 is a diagram showing a second correction example of a learning form generated by the classifier evaluation device according to an embodiment of the present invention;

FIG. 8 is a diagram showing a third correction example of a learning form generated by the classifier evaluation device according to an embodiment of the present invention;

FIG. 9 is a diagram showing a fourth correction example of a learning form generated by the classifier evaluation device according to an embodiment of the present invention;

FIG. 10 is a diagram showing an example of correction information generated by the classifier evaluation device according to an embodiment of the present invention;

FIG. 11 is a diagram showing an example of correction of the classification dependency result table generated by the classifier evaluation device according to an embodiment of the present invention;

FIG. 12 is a diagram showing an example of data counts obtained by the classifier evaluation device according to an embodiment of the present invention;

FIG. 13 is a diagram showing an example of correction rates calculated by the classifier evaluation device according to an embodiment of the present invention;

FIG. 14 is a diagram showing an example of an evaluation of a model according to the classifier evaluation device according to an embodiment of the present invention; and

FIG. 15 is a flow chart showing an example of operations according to a classifier evaluation method according to an embodiment of the present invention.

### DETAILED DESCRIPTION

Hereinafter, embodiments of the present invention will be described with reference to the drawings.

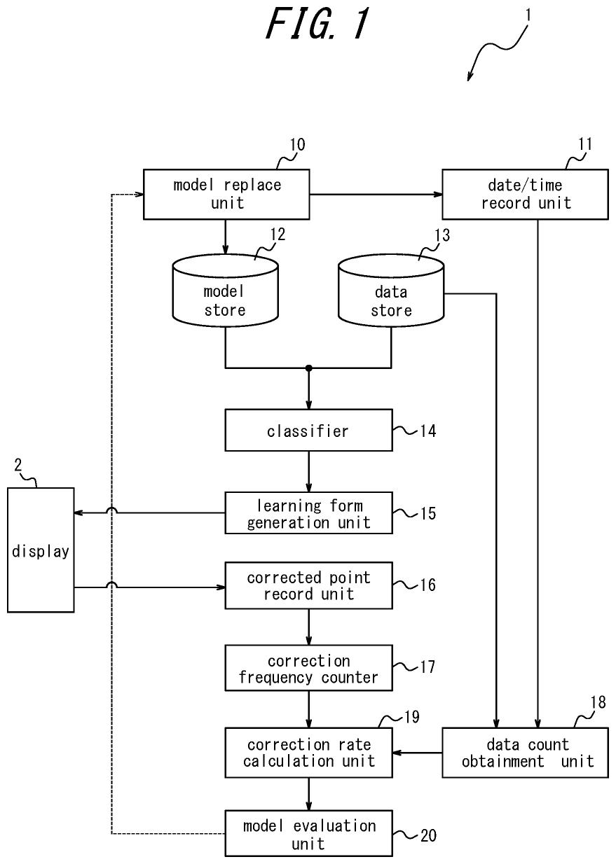

FIG. 1 shows an example configuration of a classifier evaluation device according to an embodiment of the present invention. The classifier evaluation unit 1 of FIG. 1 comprises a model replace unit 10, a date/time record unit 11, a data store 13, a classifier 14, a learning form generation unit 15, a corrected point record unit 16, a correction frequency counter 17, a data count obtainment unit 18, a correction rate calculation unit 19, and a model evaluation unit 20. The classifier evaluation device 1 may have a display 2 or a display 2 may be provided external to the classifier evaluation device 1.

The classifier evaluation device 1 is a device for quickly and accurately confirming how much an active classifier for classifying input data conforms to input data for which no ground truth exists.

The model replace unit 10 replaces the classifier stored in the model store 12. In the present embodiment, the classifier is based on a model, and the model replace unit 10 replaces the model stored in model store 12 with a newly trained model. Training data used for training of the model may, in addition to new data subsequent to replacement of the previous model, include data accumulated prior thereto, and may only include newly added data. Moreover, the model replace unit 10 may, based on the evaluation result of the model evaluation unit 20 as described below, automatically replace the model. Further, the model replace unit 10 may replace the model stored in the model store 12 with a model trained with correction information generated by the corrected point record unit 16, as described below.

The date/time record unit 11 records the date and time that the model stored in model store 12 was replaced.

The classifier 14 takes the data stored in data store 13 as an input data group and, with respect to the input data group, uses the model stored in model store 12 to perform a classification to generate a classification result.

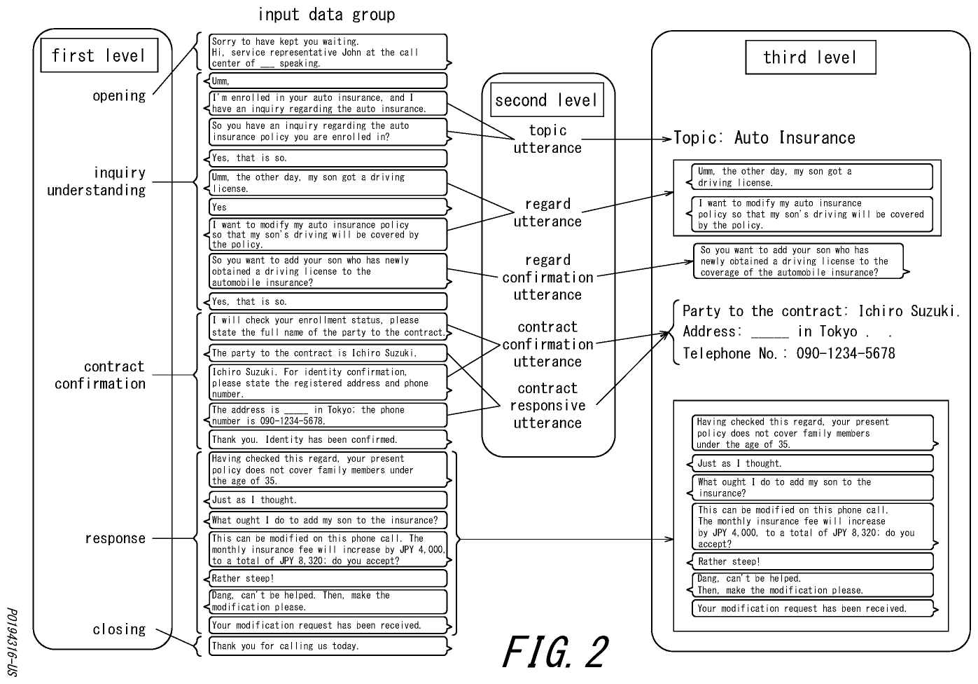

In the present embodiment, a system in which the classifier 14 classifies the input data group using multiple classifiers that are hierarchically combined is described. FIG. 2 is a diagram showing an example of input data group classification using multi-class classifiers. In the example of FIG. 2, the input data group includes documents representing the content of a dialogue between a customer and a service person (e.g. an operator) by telephone or chat. The input data group is stored in data store 13.

A first level (top level) classifier (hereinafter, “the primary classifier”) predicts the dialogue scene, a second level classifier (hereinafter, “the secondary classifier”) predicts an utterance type, and a third level classifier (hereinafter “the tertiary classifier”) predicts or extracts utterance focus point information. Moreover, speech balloons positioned on the right side are segments that indicate utterance content of the operator, and speech balloons positioned on the left side are segments that indicate utterance content of the customer. Segments representing utterance content may be segmented at arbitrary positions to yield utterance units (input data units), and each speech balloon in FIG. 2 stipulates input data of an utterance unit. Below, a system for classifying input data groups using these three-level classifiers according to the present embodiment will be described.

The primary classifier predicts the dialogue scene in a contact center, and in the example given in FIG. 2, classification into five classes is performed: opening, inquiry understanding, contract confirmation, response, and closing. The opening is a scene in which dialogue initiation confirmation is performed, such as “Sorry to have kept you waiting. Hi, service representative John at the call center of ______ speaking.”.

Inquiry understanding is a scene in which the inquiry content of the customer is acquired, such as “I'm enrolled in your auto insurance, and I have an inquiry regarding the auto insurance.”; “So you have an inquiry regarding the auto insurance policy you are enrolled in?”; “Umm, the other day, my son got a driving license. I want to change my auto insurance policy so that my son's driving will be covered by the policy.”; “So you want to add your son who has newly obtained a driving license to your automobile insurance?”.

Contract confirmation is a scene in which contract confirmation is performed, such as “I will check your enrollment status, please state the full name of the party to the contract.”; “The party to the contract is Ichiro Suzuki.”; “Ichiro Suzuki. For identity confirmation, please state the registered address and phone number.”; “The address is ______ in Tokyo, and the phone number is 090-1234-5678.”; “Thank you. Identity has been confirmed.”.

The response is a scene in a response to an inquiry is performed, such as “Having checked this regard, your present policy does not cover family members under the age of 35.”; “What ought I do to add my son to the insurance?”; “This can be modified on this phone call. The monthly insurance fee will increase by JPY 4,000, to a total of JPY 8,320; do you accept?”.

The closing is a scene in which dialogue termination confirmation is performed, such as “Thank you for calling us today.”

The secondary classifier further predicts, with respect to the dialogue for which the dialogue scene was predicted by the primary classifier, the utterance type in an utterance-wise manner. The secondary classifier may use multiple models to predict multiple kinds of utterance types. In the present embodiment, with respect to a dialogue for which the dialogue scene is predicted to be inquiry understanding, a topic utterance prediction model is used to predict whether, utterance unit-wise, utterances are topic utterances; a regard utterance prediction model is used to predict whether, utterance unit-wise, utterances are regard utterances; and a regard confirmation utterance prediction model is used to predict whether, utterance unit-wise, utterances are regard confirmation utterances. Further, with respect to dialogue for which the dialogue scene is predicted to be contract confirmation, a contract confirmation utterance prediction model is used to predict whether, utterance unit-wise, utterances are contract confirmation utterances; and a contract responsive utterance prediction model is used to predict whether, utterance unit-wise, utterances are contract responsive utterances.

A topic utterance is an utterance by the customer that is intended to convey the topic of the inquiry. A regard utterance is an utterance by the customer that is intended to convey the regard of the inquiry. A regard confirmation utterance is an utterance by the service person that is intended to confirm the inquiry regard (e.g. a readback of the inquiry regard). A contract confirmation utterance is an utterance by the service person that is intended to confirm the details of the contract. A contract responsive utterance is an utterance by the customer that is intended to, with respect to the contract content, provide a response to the service person.

The tertiary classifier predicts or extracts, on the basis of the classification results of the primary and secondary classifiers, utterance focus point information. Specifically, from utterances predicted by the secondary classifier to be topic utterances, the focus point information of the topic utterances is predicted using the topic prediction model. Further, from utterances predicted by the secondary classifier to be regard utterances, the entirety of the text is extracted as the focus point information of the regard utterances, and from utterances predicted by the secondary classifier to be regard confirmation utterances, the entirety of the text is extracted as the utterance focus point information of the regard confirmation. Further, from utterances predicted by the secondary classifier to be contract confirmation utterances and utterances predicted to be contract responsive utterances, the name of the party to the contract, the address of the party to the contract and the telephone number of the party to the contract are extracted. The extraction of the name of the party to the contract, the address of the party to the contract and the telephone number of the party to the contract may be performed using models and also may be performed in accordance with pre-stipulated rules.

The classifier 14, in accordance with a classification dependency relation table prescribing the order of implementation of the classifiers (combination of classifiers), performs a multi-class classification with respect to the input data group and generates a classification results table representative of the classification results. As to classification methods, any known method such as SVM, deep neural network (DNN) and the like may be applied. Further, classification may be performed in accordance with prescribed rules. The rules may include, in addition to exact matching, forward-matching, backward-matching, and partial matching of strings or words, matching based on regular expressions.

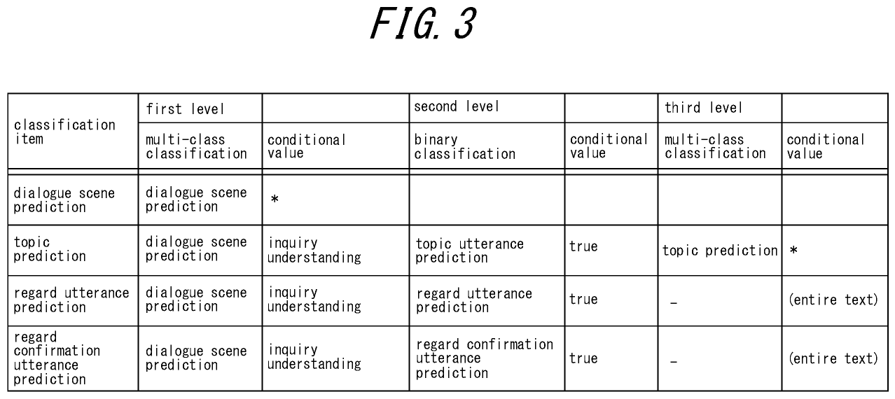

FIG. 3 is a diagram showing an example of a classification dependency relation table. For example, in a case in which the classification item is topic prediction, the primary classifier performs dialogue scene prediction at the first level, and in a case in which the multi-class classification result is “inquiry understanding”, proceeds to the second level. At the second level, the secondary classifier performs topic utterance prediction, and in a case in which the binary classification result is “true”, proceeds to the third level. At the third level, the tertiary classifier performs topic prediction, and outputs a multi-class classification result. Further, in a case in which the classification item is regard utterance prediction, the primary classifier performs dialogue scene prediction at the first level, and in a case in which the multi-class classification result is “inquiry understanding”, proceeds to the second level. At the second level, the secondary classifier performs topic utterance prediction, and in a case in which the binary classification result is “true”, proceeds to the third level. At the third level, the entirety of the text is unconditionally outputted.

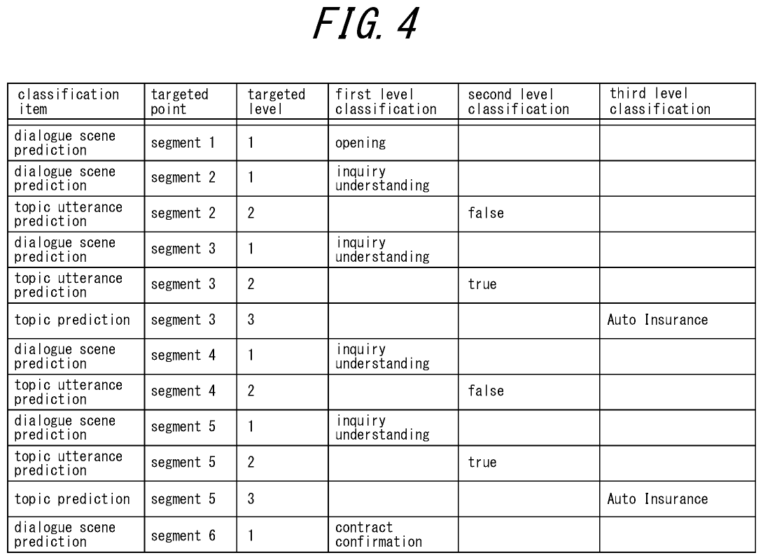

FIG. 4 is a diagram showing an example of a classification results table generated, prior to manual correction, by the multi-class classifier 12. For each classification, the “targeted point” represents a number for identifying which segment out of the documents constituting the input data was targeted for classification execution. The “targeted level” indicates the level of the classification within the dependency hierarchy, i.e. the level of the classifier that classified the segment indicated in the targeted point. The “first level classification” indicates the classification results of the primary classifier, the “second level classification” indicates the classification results of the secondary classifier, and the “third level classification” indicates the classification results of the tertiary classifier.

The learning form generation unit 15 creates a learning form having classification results based on the classification results table generated by the multi-class classifier 14 and a correction interface for rectifying said classification results, and causes the learning form to be displayed on the display 2. The correction interface is an object for rectifying the classification results and is associated with the classification level and the targeted point.

Specifically, the learning form generation unit 15 creates a learning form which shows, in a differentiated manner for the respective classification results, the classification results from the first level (top level) classifier, and shows, within the region for displaying the classification results by the first level classifier, classification results by the classifiers of the remaining levels.

Further, the learning form generation unit 15 generates a correction interface including buttons for adding classification results, buttons for deleting classification results, and regions for inputting corrected classification results. Moreover, in some embodiments correction may be possible by clicking the classification results display region, and in this case the classification results display region and the post-correction classification results input area become one and the same.

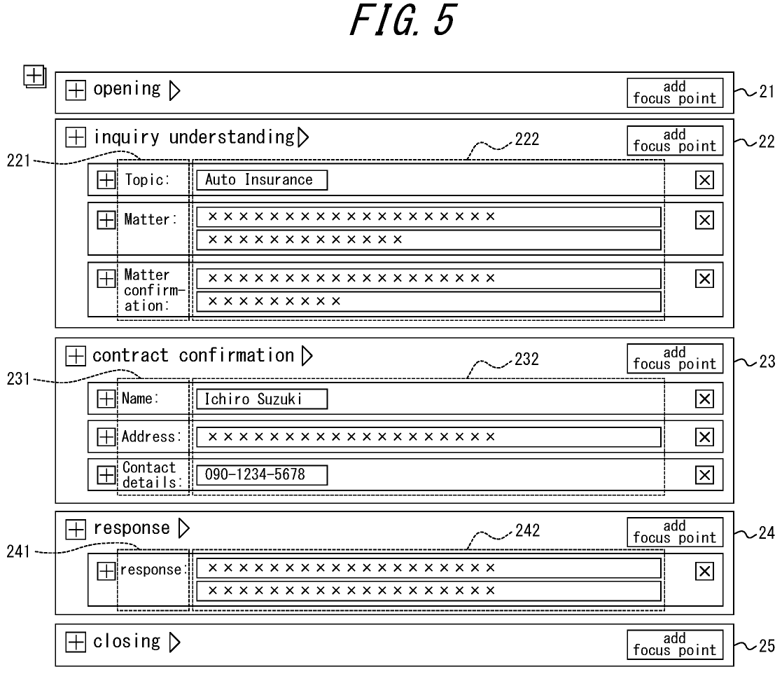

FIG. 5, similar to FIG. 2, is a diagram showing an example of a learning form in a case in which a classifier is caused to perform classification based on a dialogue between the customer and the service person as the input data. The learning form has primary display regions 21 through 25 for showing, in a differentiated manner for the respective classification results, the classification results from the primary classifiers. Each of the primary display regions may, in a case in which there are classification results from the secondary classifiers, have a secondary display region for displaying the corresponding classification results; and in a case in which there are classification results (inclusive of extraction results of utterance focus point information) from the tertiary classifiers, have a tertiary display region for displaying the corresponding classification results. Only classification results with a value of “true” are displayed for the secondary classifier classification results, and the tertiary classifier classification results are displaced adjacent to the secondary classifier classification results.

In FIG. 5, in a case in which the classification result is “true” when the topic utterance prediction model is used as the secondary classifier, “topic” is displayed; in a case in which the classification result is “true” when application of the regard utterance prediction model is used as the secondary classifier, “regard” is displayed; and in a case in which the classification result is “true” when the regard confirmation utterance prediction model is used as the secondary classifier, “regard confirmation” is displayed. Further, in a case in which the classification result is “true” when the contract confirmation utterance prediction model or the contract responsive utterance prediction model is used as the secondary classifier, “name”, “address”, and/or “contact details” are displayed.

Specifically, the primary display region 21 displays only “opening” which is the classification result of the primary classifier, and the primary display region 25 display only “closing” which is the classification result of the primary classifier.

The primary display region 22 displays “inquiry understanding” which is the classification result of the primary classifier. If the classification dependency relation table is followed, in a case in which the classification result of the primary classifier is “inquiry understanding”, the processing proceeds to the second level. Then, utterance type prediction is performed at the second level and, in a case in which the result of this is “true”, the processing proceeds to the third level. For this purpose, the primary display region 22 displays “topic”, “regard”, and “regard confirmation”, which indicate the classification results at the secondary classifier is “true” in secondary display region 221. Further, the classification results relating to topic utterances and extraction results relating to utterance focus point information of regard utterances and regard confirmation utterances are displayed in the tertiary display region 222. Moreover, as extraction results relating to utterance focus point information of regard utterances and regard confirmation utterances are often similar, only one of them may be displayed.

Similarly, the primary display region 23 displays “contract confirmation” which is the classification result of the primary classifier, and “name”, “address”, and “contact details”, which indicate that the classification results of the secondary classifier is “true”, are displayed in the secondary display region 231. Further, with respect to “name”, “address”, and “contact details”, extraction results pertaining to utterance focus point information are displayed in the tertiary display region 232.

In the example shown in FIG. 2, in a case in which the classification result of the primary classifier is “response”, classification by the secondary classifier is not performed, and the entirety of the text of the utterance for which the dialogue scene was predicted to be “response” is extracted. Thus, although primary display region 24 need not have the secondary display region, in the interest of readability and in a manner similar to the primary display regions 22, 23, a secondary display region 241 is provided in FIG. 5 and “response” is displayed therein. Further, with respect to “response”, extraction results pertaining to utterance focus point information are displayed in the tertiary display region 242.

Further, as part of the correction interface, in the primary display regions 21 to 25, “add focus point” buttons for adding utterance focus point information are displayed, and in the primary display regions 22 to 24, “X” buttons, shown by X symbols, for deleting utterance focus point information are displayed.

With respect to the third level topic prediction results shown in the tertiary display region 222, in a case in which the prediction is from multiple candidates, a user can select from a pulldown to perform a correction and save action. Further, with respect to the third level utterance focus point information extraction results shown at tertiary display regions 232, 242, the user can rectify and save the text. Unnecessary utterance focus point information can be deleted by depressing the “X” button.

The corrected point record unit 16 generates correction information that records the correction point and the corrected classification results in a case in which the learning form created by the learning form generation unit 15 has been corrected by the user via the correction interface (i.e. in a case in which the classification results have been corrected). Moreover, the user can perform correction on classification results in the midst of the multiple levels, via buttons associated with the classification levels. Correction includes modification, addition, and deletion.

Further, in a case in which a classification result of a classifier of a particular level is corrected, the corrected point record unit 16 also rectifies classification results of classifiers at levels higher than said particular level in conformance with the classification result correction. In a case in which there is no need to rectify the classification results of the top level classifier, it can be left at that. For example, in the present embodiment, even if the classification result of the topic utterance prediction by the secondary classifier was left at “true” and not subjected to correction, in a case in which the classification result of the topic prediction by the tertiary classifier was deleted, because it implies that the classification result of the secondary classifier was incorrect, the classification result of the secondary classifier is corrected from “true” to “false”. It suffices to go back to the binary classification at the second level, and it is not necessary to go back to the first level.

Further, corrected point record unit 16 may, in a case in which a classification result of a classifier of a particular level is corrected, also exclude, from the training data, classification results of classifiers of levels lower than said particular level in conformance with the classification result correction. For example, in the present embodiment, in a case in which the classification result of dialogue scene prediction by the primary classifier is corrected from “inquiry understanding” to “response” and in a case in which the classification result of the regard utterance prediction by the secondary classifier is predicted to be “true”, then “true” is excluded from the training data. Moreover, corrected point record unit 16 checks for the existence of corrections from the higher levels and if there are no corrections, it then checks for existence of corrections at the lower levels. Thus, hypothetically, even if the user, after having corrected the topic prediction classification result of the tertiary classifier, went on to rectify the dialogue scene prediction classification result of the primary classifier, the topic prediction correction of the tertiary classifier would, in a case in which the dialogue scene prediction of the primary classifier is not “inquiry understanding”, be deleted from the training data because the corrected point record unit 14 checks from the corrections at the first level.

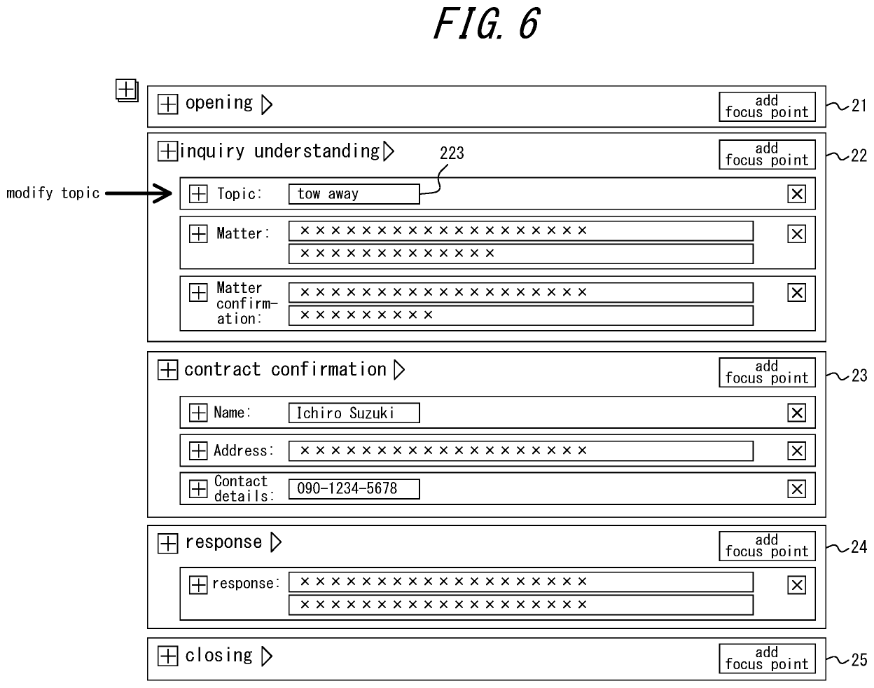

FIG. 6 shows a first example of correction in the learning form. The user can modify the topic displayed in the topic display region 223. For example, when the topic display region 223 displaying topic prediction results is clicked on by the user, the display 2 displays a pulldown listing the selectable topics. The user can, by selecting one or more topics from the listing of topics, modify the topic. In this example, the user, modifies the third level topic prediction result of “auto insurance” displayed in the primary display region 22 to “tow away”. Where such a correction is performed, corrected point record unit 16 changes the third level topic prediction result from “auto insurance” to “tow away”.

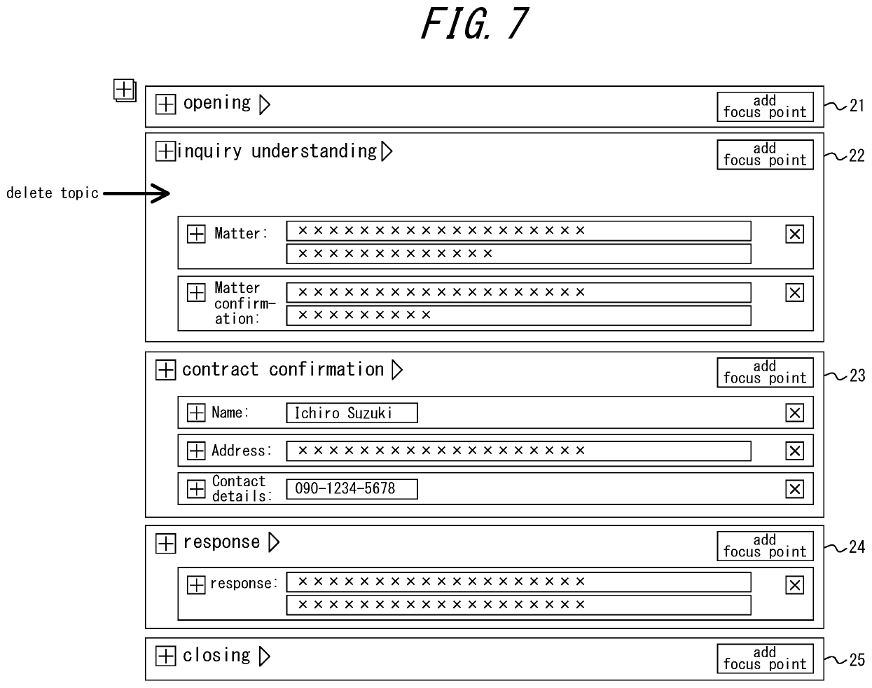

FIG. 7 shows a second example of correction in the learning form. If the “X” button is depressed by the user, the display 2 stops displaying the second and third levels. In this example, the user deletes the utterance type “topic”, that is a second level prediction result of “true” shown in the primary display region 22. Where such a correction is performed, corrected point record unit 16 deletes the third level topic prediction result together with changing the second level topic utterance prediction result from “true” to “false”.

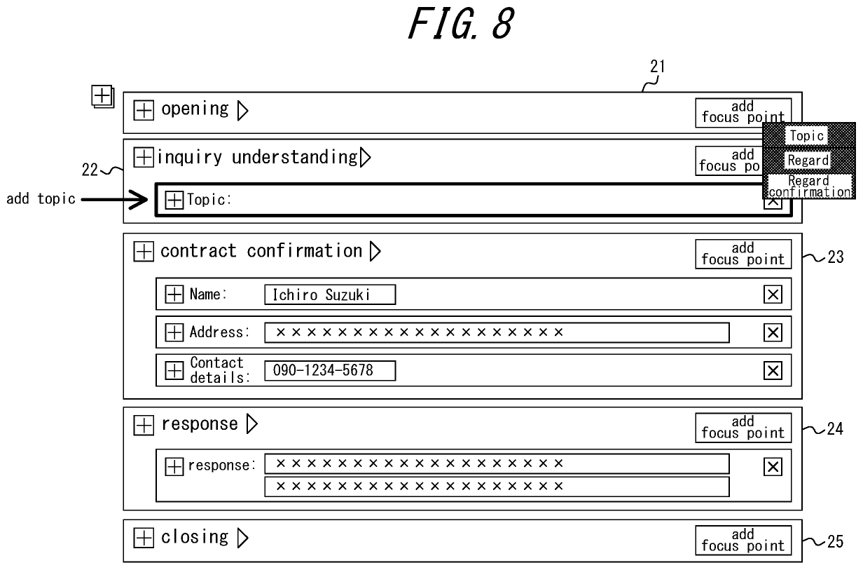

FIG. 8 shows a third example of correction in the learning form. If the “add focus point” button is depressed by the user, the display 2 displays a pulldown list of buttons that can be selected regarding the utterance types corresponding to the utterance focus point information that can be added. If any of the buttons shown in the pulldown trained on the “add focus point” button is selected, the utterance focus point information input field corresponding to the utterance type indicated by the selected button is displayed. Shown here is an example regarding addition of a “topic” input field, in which the user depresses the “add focus point” button shown in the primary display region 22, and selects “topic” from “topic”, “regard”, and “regard confirmation” displayed in the pulldown. When such a correction is performed, the corrected point record unit 16 changes the second level topic utterance prediction result from “false” to “true”.

Moreover, in a case in which topic addition is concerned, the user can, by selecting via clicking and the like on separately displayed utterance data, establish an association with utterances corresponding to the topic. For example, in a case in which, in the interest of differentiation from other utterance data, a prescribed background color is to be applied to utterance data predicted, by the topic utterance prediction model, to be a topic utterance, a scenario in which the topic utterance prediction model prediction is erroneous may occur; this scenario causing non-application of the background color necessary for inducing the service person to recognize that the utterance data concerns a topic utterance. In this case, by clicking on the utterance data recognized as being a topic utterance, the prescribed background color will be applied. Further, if the prescribed background color has been applied on the utterance data on the basis of the operations of the service person, utterance types may be added in correspondence to the utterance data.

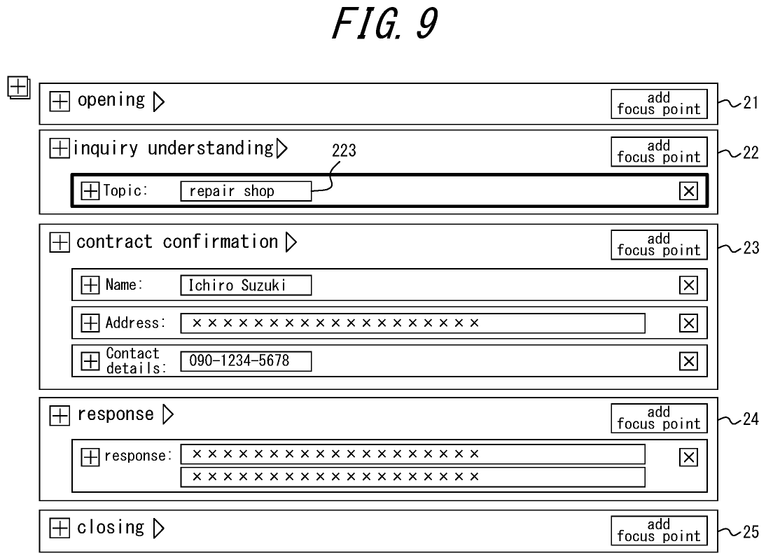

FIG. 9 shows a fourth example of correction in the learning form. As shown in FIG. 8, even with situations in which a topic has been added, were the topic display region 223 displaying topic prediction results to be clicked upon by the user, the display 2 will display via pulldown action a list of the selectable topics. Shown here is an example regarding topic prediction entailing clicking, after the user having added the “topic”, the topic display region 223 and selecting “repair shop” from the listing of topics displayed in the pulldown. In a case which such a correction is performed, corrected point record unit 16 adds “repair shop” as a third level topic prediction result.

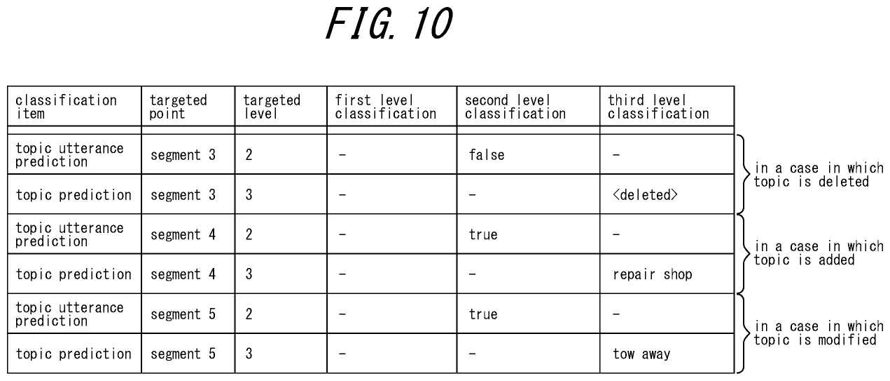

FIG. 10 is a diagram illustrating an example of correction information generated by the corrected point record unit 16. Correction information concerning the correction shown in FIGS. 6 to 9 and performed by the user is shown. The format of the correction information is the same as the classification dependency relation table. With respect to segment 3, in a case in which the user deletes the “topic” as shown in FIG. 7, the corrected point record unit 16 deletes the third level topic prediction result of segment 3.

Further, because the user understands that the utterance type of segment 3 is not a topic utterance, the corrected point record unit 16 changes the second level topic utterance prediction result to “false”.

With respect to segment 4, in a case in which the user adds “topic”, as shown in FIGS. 8 and 9, the corrected point record unit 16 adds “repair shop” as the third level topic prediction result for segment 4. Further, because the user understands that the utterance type of segment 4 is a topic utterance, the corrected point record unit 16 changes the second level topic utterance prediction result to “true”.

With respect to segment 5, in a case in which the user modifies the “topic”, as shown in FIG. 6, the corrected point record unit 16 changes the third level topic prediction result for segment 5 to “tow away”. Further, because the user understands that the utterance type of segment 5 is a topic utterance, the corrected point record unit 16 maintains the second level topic utterance prediction result as “true”.

The correction frequency counter 17 counts, in a case in which the classification result has been corrected, from the correction information, for each classification item (i.e. for each of the models for which classification results have been generated), the correction frequency, and outputs the correction frequency to the correction rate calculation unit 19. In a case in which a correction rate comparable to that of a conformance rate (precision) is required, the correction frequency counter 17 counts the frequency of modifications and deletions for the correction frequency; and in a case in which a correction rate comparable to that of a recall rate (recall) is required, the correction frequency counter 17 counts the frequency of additions for the correction frequency. Further, the correction frequency counter 17 may count an aggregate of the frequency of modifications, deletions, and additions, for the correction frequency, without discriminating.

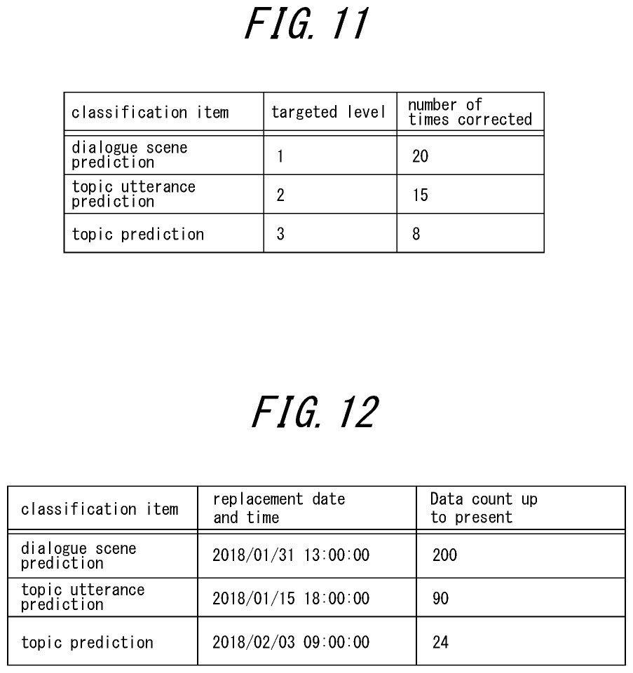

FIG. 11 shows an example of correction frequency counting by the correction frequency counter 17. Here, with respect to each of the classification items “dialogue scene prediction”, “topic utterance prediction”, and “topic prediction”, the targeted level and correction frequency are shown. The correction frequency is an aggregate of the frequencies of modification, deletion, and addition.

The data count obtainment unit 18 obtains, for each of the classification items, an input data count to be targeted for classification. In the present embodiment, the data count is the document count in terms of utterance units. Moreover, the data count may be the document count for which the pertinent classification was performed, or the document count for the entirety. For example, the data count obtainment unit 18 obtains the date and time that the model replace unit 10 replaced the model from the date/time record unit 11, and obtains the data count for classified data (i.e. the input data count to be targeted for classification) from the time at which the model was replaced by the model replace unit 10 to the present (i.e. subsequent to the model update date). In this case, the correction frequency counter 17 counts the correction frequency after the model update date. Further, the correction frequency counter 17 may, each time the classifier is updated, delete the correction information.

FIG. 12 shows an example of data count obtainment by the data count obtainment unit 18. Here, with respect to each of the classification items “dialogue scene prediction”, “topic utterance prediction”, and “topic prediction”, the date and time of model replacement and the data count up to the present are shown.

The correction rate calculation unit 19 calculates, for each classification item, the correction rate from the correction frequency counted by the correction frequency counter 17 and the data count obtained by the data count obtainment unit 18, and outputs the calculation result to the model evaluation unit 20. For example, the correction rate is set to the value of the correction frequency divided by the data count.

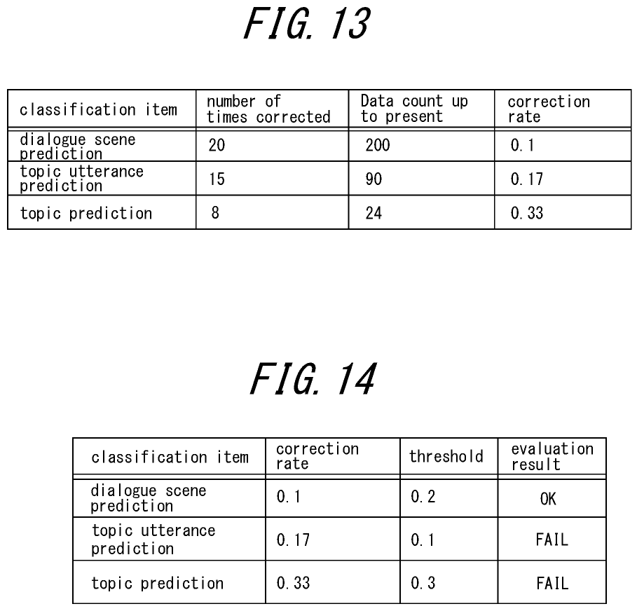

FIG. 13 shows an example of correction rates by the correction rate calculation unit 19. Using values shown in FIGS. 11 and 12, the correction rate is 20/200=0.1 for the classification item “dialogue scene prediction”, the correction rate is 15/90=0.17 for the classification item “topic utterance prediction”, and the correction rate is 8/24=0.33 for the classification item “topic prediction”.

The model evaluation unit 20 outputs the correction rate calculated by correction rate calculation unit 19. For example, the display 2 is caused to display the correction rate.

Further, the model evaluation unit 20 may evaluate the model based on the correction rate calculated by the correction rate calculation unit 19, and output the evaluation result. For example, the model may be evaluated by predicting whether the correction rate satisfies a preset threshold condition, and the display 2 may be caused to display the evaluation result. In a case in which the correction rate exceeds the threshold, a notification may be given, and, for example, a warning may be issued to indicate that the evaluation result has failed. The threshold may be a fixed value, or it may be the correction rate of the previously used model.

In a case in which the model stored in the model store 12 is to be manually replaced, it suffices to merely display the correction rate. On the other hand, in a case in which the model is to be automatically replaced, if the correction rate exceeds the threshold, the model evaluation unit 20 commands (notifies) the model replace unit 10 to replace the model. Then, the model replace unit 10 replaces the model, based on commands from the model evaluation unit 20, the model.

FIG. 14 shows an example of an evaluation according to the model evaluation unit 20. For the classification item “dialogue scene prediction”, as the correction rate is at or less than the threshold, the evaluation result is “OK”; for the classification item “topic utterance prediction”, as the correction rate exceeds the threshold, the evaluation result is “Fail”; and for the classification item “topic prediction”, as the correction rate exceeds the threshold, the evaluation result is “Fail”.

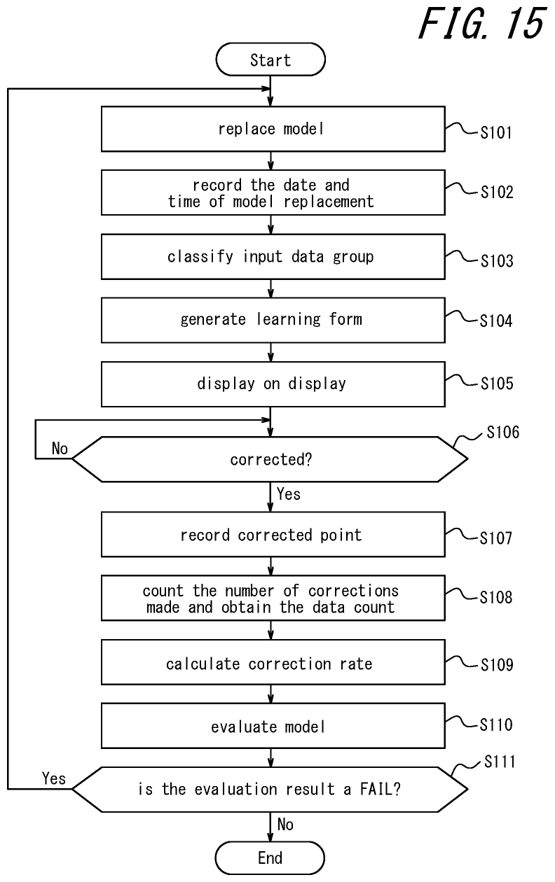

Next, a classifier evaluation method in relation to classifier evaluation device 1 is explained. FIG. 15 is a flow chart showing how an example classifier evaluation method may operate according to an embodiment of the present invention.

The classifier evaluation device 1 replaces, using the model replace unit 10, a model stored in the model store 12, with a new model (S101). At this time, using the date/time record unit 11, the date and time of the model replacement is recorded (S102).

Next, the classifier evaluation device 1, using the classifier 14, classifies the input data group (S103). Moreover, though the abovementioned embodiment describes an example in which multiple classifiers were hierarchically combined, one classifier may be used for the classification.

Next, the classifier evaluation device 1 creates, using the learning form generation unit 15, the learning form (S104), and causes the display 2 to display the learning form (S105). Once the learning form displayed on the display 2 is corrected by the user (S106—Yes), the classifier evaluation device 1 records, using corrected point record unit 16, the corrected point (S107). The classifier evaluation device 1 counts, using the correction frequency counter 17, the correction frequency after the model update date, and obtains, using the data count obtainment unit 18, the data count after the model update date (S108), and calculates, using the correction rate calculation unit 19, the correction rate (S109).

Finally, the classifier evaluation device 1 evaluates, using the model evaluation unit 20, the model being currently used (S110). In a case in which the evaluation result is failure (S111—Yes), the model stored in the model store 12 is replaced using the model replace unit 10 (S101). Moreover, the processing steps from S107 to S109 may be performed each time a correction is made, or may be performed at a prescribed timing. As the degree of confidence is low when the data count (population) is low, it is desirable for the processing of step S110 to be performed when the data count exceeds the threshold.

Moreover, a computer may be used to realize the functions of the abovementioned classifier evaluation device 1, and such a computer can be realized by causing a CPU of the computer to read out and execute a program, wherein the program describes procedures for realizing the respective functions of the classifier evaluation device 1, and is stored in a database of the computer.

Further, the program may be recorded on a computer readable medium. By using the computer readable medium, installation on a computer is possible. Here, the computer readable medium on which the program is recorded may be a non-transitory recording medium. Though the non-transitory recording medium is not particularly limited, it may be a recording medium such as a CD-ROM and/or a DVD-ROM, for example.

As explained above, according to the present invention, with respect to data being accumulated on a daily basis, the classification and prediction results are confirmed and the correction rate is calculated, based on the number of times an error was corrected and a case count of the targeted data. By doing so, the accuracy of the currently used model, that is, how much it conforms to data for which no ground truth exists, can be quickly and accurately predicted. Moreover, by letting the correction rate vary, accuracy comparable to the recall rate and accuracy comparable to the conformance rate may be obtained.

Further, according to the present invention, as the model may be quickly evaluated based on the correction rate, it becomes possible to automatically update the model at an appropriate timing. For example, the model may be updated on the condition that the correction rate exceeds a preset threshold.

Further, according to the present invention, the user can readily rectify classification results by causing display of a learning form having the classification results from the classifiers and a correction interface for rectifying the classification results. Thus, operability may be improved.

Although the above embodiments have been described as typical examples, it will be evident to the skilled person that many modifications and substitutions are possible within the spirit and scope of the present invention. Therefore, the present invention should not be construed as being limited by the above embodiments, and various changes and modifications can be made without departing from the claims. For example, it is possible to combine a plurality of constituent blocks described in the configuration diagram of the embodiment into one, or to divide one constituent block.

### REFERENCE SIGNS LIST

1 classifier evaluation device
2 display
10 model replace unit
11 date/time record unit
12 model store
13 data store
14 classifier
15 learning form generation unit
16 corrected point record unit
17 correction frequency counter
18 data count obtainment unit
19 correction rate calculation unit
20 model evaluation unit
21 to 25 first display region
221, 231, 241 second display region
222, 232, 242 third display region
223 topic display region

1. A classifier evaluation device for evaluating classifiers performing classification of input data, the classifier evaluation device comprising:
a computer that obtains a data count of input data to be made a classification target,
counts a correction frequency of the classifiers, from correction information on classification results for the classifiers, and
calculates, based on the correction frequency and the data count of input data, a correction rate for each of the classifiers.

2. The classifier evaluation device according to claim 1, wherein the computer counts the correction frequency made after an update date of the classifiers.

3. The classifier evaluation device according to claim 1, wherein the computer deletes the correction information each time the classifiers are updated.

4. The classifier evaluation device according to claim 1, wherein the computer counts a frequency of modifications and deletions, or the frequency of additions as the correction frequency.

5. The classifier evaluation device according to claim 1, wherein the computer issues a notification in a case in which the correction rate exceeds a preset threshold.

6. The classifier evaluation device according to claim 5, wherein the classifiers are based on models, and the computer replaces the model with a model trained with the correction information.

7. The classifier evaluation device according to claim 1, wherein the computer generates the correction information in a case in which the classification result is corrected via a correction interface.

8. The classifier evaluation device according to claim 7, wherein the correction interface includes a button for adding a classification result, a button for deleting a classification result, and a region for inputting a post-correction classification result.

9. A classifier evaluation method for evaluating classifiers performing classification of input data, the method comprising:
obtaining a data count of input data to be made a classification target;
counting a correction frequency of the classifiers, from correction information on classification results for the classifiers; and
calculating, based on the correction frequency and the data count of input data, a correction rate for each of the classifiers.

10. A non-transitory computer readable recording medium recording a program for causing a computer to function as a classifier evaluation device according to claim 1.

11. The classifier evaluation device according to claim 2, wherein the computer counts a frequency of modifications and deletions, or the frequency of additions as the rectification frequency.

12. The classifier evaluation device according to claim 3, wherein the computer counts a frequency of modifications and deletions, or the frequency of additions as the rectification frequency.

13. The classifier evaluation device according to claim 2, wherein the computer issues a notification in a case in which the correction rate exceeds a preset threshold.

14. The classifier evaluation device according to claim 3, wherein the computer issues a notification in a case in which the correction rate exceeds a preset threshold.

15. The classifier evaluation device according to claim 4, wherein the computer issues a notification in a case in which the correction rate exceeds a preset threshold.

16. The classifier evaluation device according to claim 2, wherein the computer generates the correction information in a case in which the classification result is corrected via a correction interface.

17. The classifier evaluation device according to claim 3, wherein the computer generates the correction information in a case in which the classification result is corrected via a correction interface.

18. The classifier evaluation device according to claim 4, wherein the computer generates the correction information in a case in which the classification result is corrected via a correction interface.

19. The classifier evaluation device according to claim 5, wherein the computer generates the correction information in a case in which the classification result is corrected via a correction interface.

20. The classifier evaluation device according to claim 6, wherein the computer generates the correction information in a case in which the classification result is corrected via a correction interface.
